(19) United States
(12) Patent Application Publication
(10) Pub. No.: US 2026/0274017 A1
(43) Pub. Date: Sep. 17, 2026

(54) TOW HITCH SYSTEM

(71) Applicant: Parkit360 Inc., Carleton Place (CA)

(72) Inventors: Stephen Houle, Carleton Place (CA); Stefan Houle, Carleton Place (CA); Lorne Moore-Crispin, Smith Falls (CA); Jonathan Lupick, Carleton Place (CA); Mark Wissink, Almonte (CA); Mark Warren, Carleton Place (CA); Joel Hall, Carleton Place (CA); Joshua Gagnier, Carleton Place (CA)

(21) Appl. No.: 19/223,961

(22) Filed: May 30, 2025

Related U.S. Application Data
(60) Provisional application No. 63/771,980, filed on Mar. 14, 2025.

(51) Int. Cl. B60D 1/28; B60D 1/06

(52) U.S. Cl. CPC B60D 1/28; B60D 1/06

(57) ABSTRACT

A tow hitch system is disclosed. The system includes: a ball adapter having a spherical ball head; a coupler having a recess shaped complementary to the ball head for receiving the ball head such that, following insertion of the ball adapter into the recess, the recess fully encloses the ball head of the ball adapter; and a securing feature for resisting removal of the ball adapter from the recess while permitting the ball head to rotate within the coupler about a longitudinal axis of the ball adapter.

### RELATED APPLICATIONS

This application claims priority to United States provisional application no. 63/771,980, filed on March 14, 2025, which is incorporated by reference herein.

### FIELD

The present disclosure relates to a tow hitch system for connecting a towing vehicle or dolly to a trailer or other item to be towed.

### BACKGROUND

Various tow hitch systems are known for connecting a towing vehicle or dolly to a trailer or other item to be towed. One such known system includes a ball hitch and corresponding coupler. The ball hitch is mounted or coupled to a towing vehicle, such as a truck or dolly. A corresponding coupler is mounted on the trailer or item to be towed. The coupler includes a curved, cup-like recess that receives part of the ball on the ball hitch. A latch or other securing mechanism is used to secure the coupler to the ball hitch.

FIG. 1 shows a cross-section of an existing ball hitch system, having a ball mount 10 with a ball head 12. The ball mount 10 includes a threaded stem for mounting the ball mount on a hitch connected to a towing vehicle or dolly. A ball hitch coupler 14 includes a cup-shaped end 16 with a partially spherical recess 18 that receives the ball head 12. From the recess 18 an arm 20 extends towards the trailer to be towed (not visible). The recess 18 is only partially complementary to the shape of the ball head 12 and has an internal surface 22 that only partially encloses and/or contacts the ball head 12. On an underside of the coupler and next to the recess 18 is a securing means 24 having a partially spherical surface and connected to a latch 26 on an upper side of the coupler 14. By activating the latch 26, the securing means is pulled upward to contact a portion of the surface of the ball head 12.

This known tow hitch presents disadvantages. One such disadvantage is that trial and error is often required to ensure the ball head is properly received within the recess because the ball hitch and coupler are typically manufactured by different entities, resulting in a mis-match of dimensions. Thus, installation is time consuming and this mis-match also results in poor fit even after installation. Moreover, the known tow hitch system limits the ability of the ball head to pivot within the coupler. In this case, pivoting would mean rotation about one or more axes perpendicular to a vertical, longitudinal axis L extending through the center of the ball head. Other degrees of motion may also be limited.

Therefore, improvements to tow hitch system involving a ball mount are desirable.

### BRIEF DESCRIPTION OF THE DRAWINGS

Embodiments will be described, by way of example only, with reference to the accompanying figures wherein:

FIG. 1 shows one example ball hitch system according to the prior art.

FIG. 2 shows a perspective view of a ball adapter according to embodiments of the present disclosure.

FIG. 3 shows a front view thereof.

FIG. 4 shows a perspective view of a coupler according to embodiments of the present disclosure.

FIG. 5 shows a front view thereof.

FIG. 6 shows a cross-sectional view thereof taken along line 6-6 in FIG. 5.

FIG. 7 shows a top thereof.

FIG. 8 shows a cross-sectional view thereof taken along line 8-8 in FIG. 7.

FIG. 9 shows a front view of a system according to embodiments of the present disclosure.

FIG. 10 shows a top view thereof.

FIG. 11 shows a cross-sectional view thereof taken along line 11-11 in FIG. 10.

### DETAILED DESCRIPTION

The present disclosure relates to a tow hitch system having a ball adapter and a coupler. The ball adapter includes a spherical ball head and cylindrical neck on which the ball head is mounted. The coupler includes a recess shaped complementary to both the ball head and the neck. When the ball adapter is inserted into the recess, the recess fully encloses at least the ball head of the ball adapter. A securing feature may resist removal of the ball adapter from the recess while permitting the ball head to rotate within the coupler about a longitudinal axis of the ball adapter.

This system may allow for a quick installation and removal of the ball adapter without the need for trial and error due to mis-matched dimensions, as is the case for known systems. It may also allow for a greater range of motion, both rotation and pivoting, of the ball head within the adapter. It may also reduce wear and improve the working life of the ball adapter and coupler.

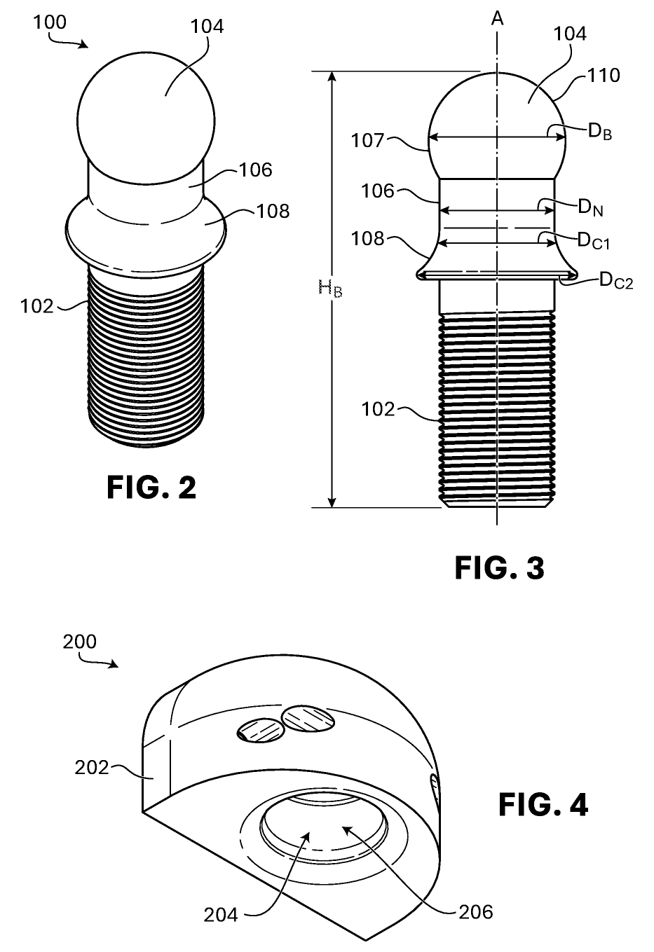

Referring to FIGS. 2 and 3, a ball adapter 100 according to embodiments of the present disclosure is shown. The ball adapter 100 has a threaded stem 102 for connecting the ball adapter 100 to, for example, a mounting stem, bracket or hitch bracket of a towing vehicle or dolly (not shown). The ball adapter 100 may also be screwed into or otherwise connected to a mounting portion of a trailer dolly or other implement for towing. A ball head 104 is mounted on a neck 106, which in turn is mounted on a flared collar 108. The ball head 104 is spherical and has a diameter D_{B}. while the neck 106 is cylindrical with a diameter D_{N} smaller than the diameter D_{B}. Thus, only a portion 107 of the spherical surface 110 of the ball head 104 is exposed for contact. The collar 108 has a curved profile that begins with a diameter D_{C1} matching the diameter D_{N} of the neck 106, which then expands to a larger diameter D_{C2} that, in the illustrated embodiment, exceeds the diameter D_{B} of the ball head 104. A vertical, longitudinal axis A extends in a longitudinal direction through a center of the stem 102, ball head 104, neck 106 and collar 108. In the illustrated embodiment, the ball adapter is symmetrical about the longitudinal axis A.

An overall height, H_{B}, of the ball adapter 100 may be defined. The height H_{B} may vary and the relative height of the neck 106 to the heigh H_{B} may differ in other embodiments.

Other embodiments of the ball adapter are possible. The relative dimensions of the ball head, neck, collar and stem may be different and are within the scope of the present disclosure. For example, more or less of the ball head’s surface may be exposed, the neck diameter may differ from the first collar diameter, etc. In some embodiments, the collar may be omitted.

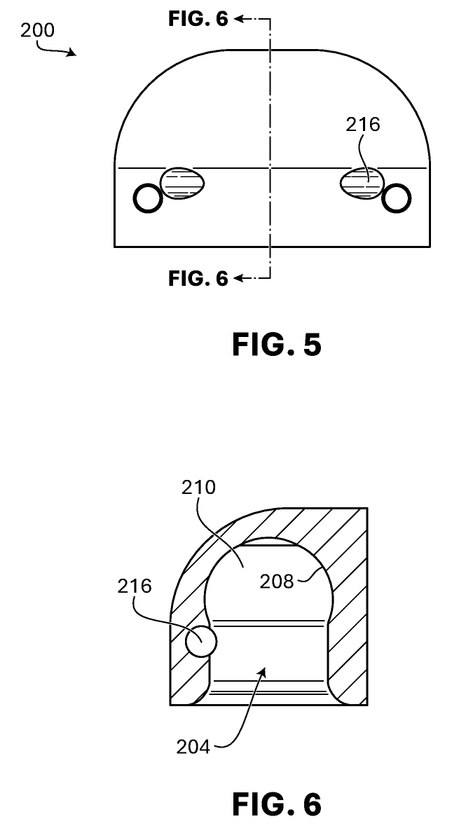

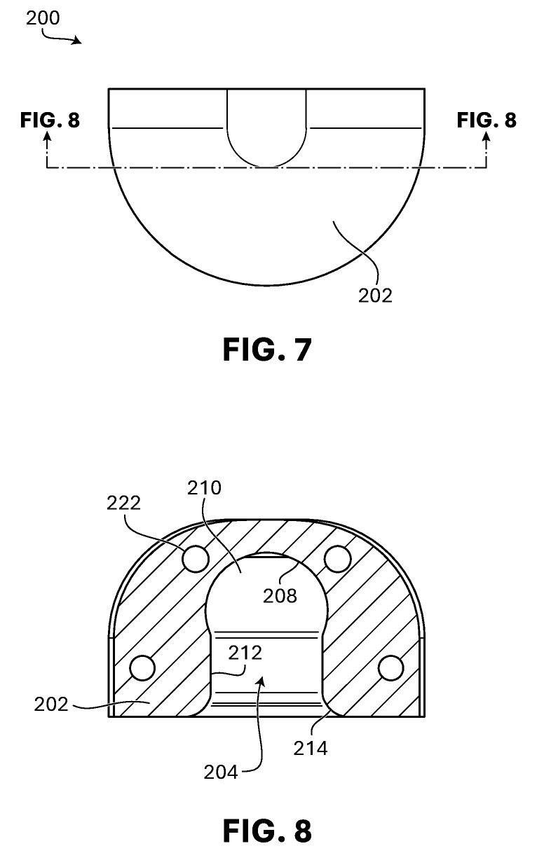

Referring to FIGS. 4 to 8, a coupler 200 according to embodiments of the present disclosure is shown. In the illustrated embodiment, the coupler 200 has a domed, unitary body 202. A recess 204 is provided within the body 202. The recess 204 has an opening 206 and an internal shape complementary to at least the shape of the ball head 104 and neck 106 of the ball adapter 100. Specifically, an internal wall 208 of the recess 204 has a spherical wall portion 210 shaped complementary to the exposed portion of the spherical surface of the ball head 104, a cylindrical wall portion 212 shaped complementary to the shape of the neck 106, and a flared wall portion 214 shaped complementary to the flared collar 108. The domed exterior of the coupler body 202 may aid in avoiding edges that can pose a hazard. However, the specific shape of the exterior of the body in the illustrated embodiment is not required and may be varied in other embodiments.

The illustrated embodiment of the coupler has a unitary body 202, meaning that the body is formed from a single blank. For example, a recess may be machined into a single blank to form the recess 204 with a desired shape.

In other embodiments, the body of the coupler may be produced from multiple pieces connected to each other.

Other embodiments of the coupler are possible. For example, the coupler need not have a domed shape and may have a different overall shape. The coupler need not be formed from a unitary piece. The internal recess may have a different shape. For example, if the ball adapter has a different shape the internal recess may be adjusted to be complementary to the ball adapter. There may be additional recesses. Some or all of the flared wall portion may be omitted. Some of the cylindrical wall portion may be omitted.

The recess 204 and opening 206 are sized and dimensioned to permit the ball adapter 100 to be inserted into the recess 204, while maintaining a predefined tolerance. Specifically, diameters of the opening and cylindrical wall portion are greater than the diameter of the ball D_{B.}

A through hole 216 is provided that runs through a portion of the body 202 of the coupler 200. In the illustrated embodiment, the through hole 216 runs laterally perpendicular to the longitudinal axis A. As best seen in FIG. 6, the through hole 216 partially intersects with and communicates with the recess 204.

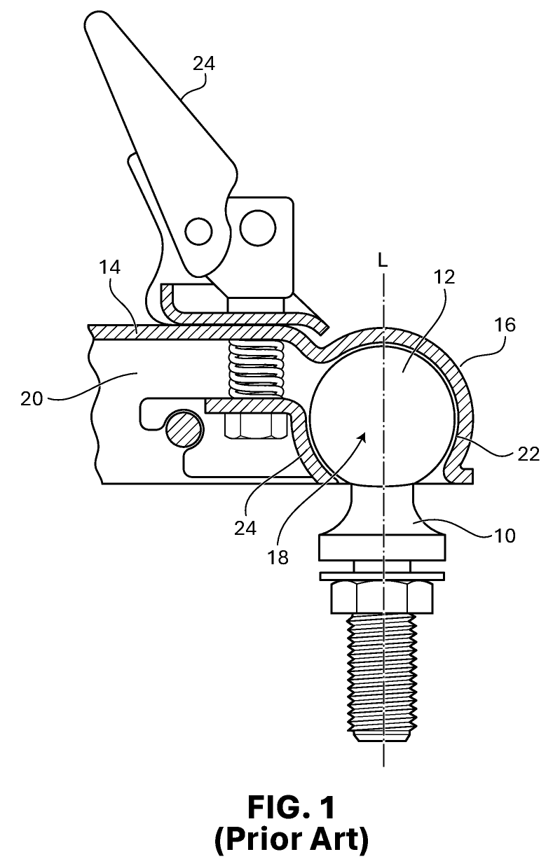

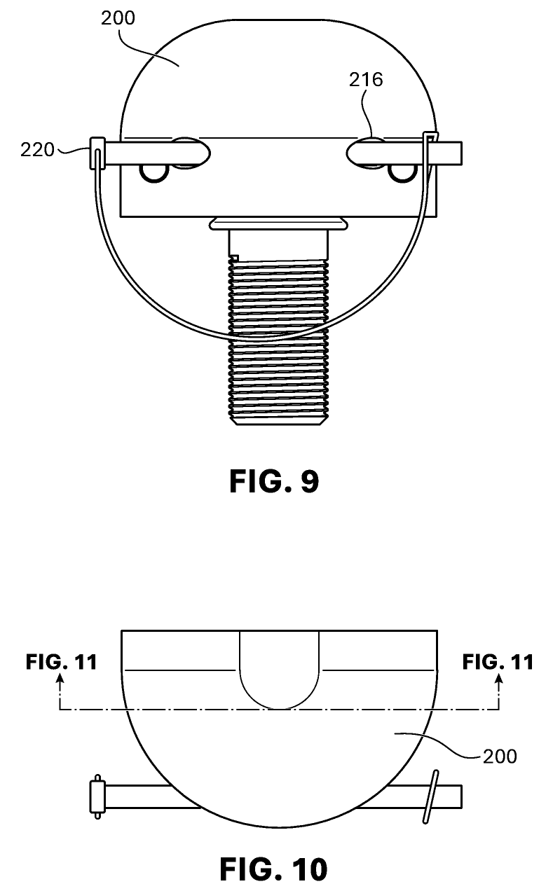

Referring to FIGS. 9 to 11, when the ball adapter 100 is received within the recess 204 – for example during operation – the internal wall 208 surrounds portions of the ball adapter 100. Specifically, in the illustrated embodiment, the spherical wall portion 210 surrounds the ball head 104, the cylindrical wall portion 212 surrounds the neck 106, and the flared wall portion 214 surrounds the flare collar 108. In this context, the term “surrounds” denotes that the wall 208 extends around an entire circumference of, for example, the neck 106 of the ball adapter 100. Put differently, the ball head 104 and at least part of the neck 106 are enclosed within the recess 204. This is in contrast to, for example, the known system shown in FIG. 1, where only a portion of the ball head 12 is enclosed by the internal surface 22.

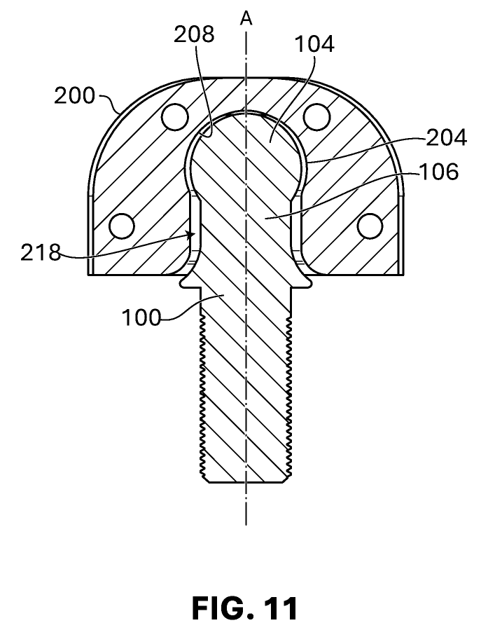

As best shown in FIG. 11, a predefined clearance, tolerance or gap 218 is provided between an outer surface of the ball adapter 100 and the wall 208 of the recess 204. The gap 218 may have a uniform thickness or its thickness may vary, as shown in the illustrated embodiment. However, the gap 218 may surround at least portions of the ball adapter 100. For example, the gap 218 may surround an entire circumference of the neck 106. The gap may aid relative movement between the ball adapter 100 and the coupler 200 without or with less damage to the ball adapter.

During operation, the ball adapter 100 is able to rotate 360 degrees about the longitudinal axis A. The ball adapter 100 is also able to pivot, i.e. rotate about one or more axes perpendicular to the longitudinal axis, for example one or more axes perpendicular to the longitudinal axis and passing through the center of the spherical ball head 104. The gap 218 may allow for some degree of freedom of movement when the ball adapter 100 pivots. In particular, in the illustrated embodiment, the gap 218 has a greater thickness adjacent the neck 106 and collar 108 that may allow for pivoting of the ball adapter 100.

To prevent or resist removal of the ball adapter 100 from recess 204 during operation, for example due to relative movement of the ball adapter 100 and coupler 200, a securing feature may be installed. In the illustrated embodiment, a pin 220, such as a D-pin, may be installed through the through hole 216. As seen in FIG. 6, the through hole 216 intersects the recess 204 adjacent the neck 106 and below the ball head 104. As such, the pin 220 inserted in the through hole 216 would prevent the ball head 104 from being removed from the recess 204 without hindering rotation of the ball adapter 100 about the longitudinal axis A. A thickness of the neck 106 in the longitudinal direction is wide enough to allow for placement of the pin. Put differently, the gap 218 or clearance is large enough to accommodate the pin 220 without undue interference with the ball adapter 100.

Other embodiments of securing features may be possible and are within the scope of the present disclosure. For example, any cylindrical pin or other obstruction that can pass through hole 216 could be used. More generally, other mechanical means for preventing removal from of the ball adapter from the coupler, while permitting rotation of the ball adapter about the longitudinal axis may also be used.

The coupler 200 also includes one or more mounting holes 222 for mounting the coupler 200 to a trailer or other item to be towed. The coupler 200 could be directly mounted or mounted via one or more brackets (not shown). The coupler 200 may also be installed using a mounting plate or bracket or in other ways.

Installation of the ball adapter 100 into the coupler 200 may be completed quicker than in known systems while still maintaining the desired degrees of freedom and relative movement required of the hitch. Specifically, because the recess 204 is configured to be shaped complementary to and surround at least the ball head 104 and a portion of the neck 106 of the ball adapter 100, the ball adapter 100 is merely generally aligned with the recess 204 and inserted. The securing feature, such as the pin 220, is installed to help retain the ball adapter 100 in place. Conversely, to detach or unhitch the ball adapter 100, the securing feature, such as the pine 220, is removed and the ball adapter 100 extracted from the recess 204.

Other embodiments are possible.

Numerous specific details have been set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

Methods related to the use, implementation, operation, production, etc. of the tow hitch system disclosed herein are also within the scope of the present disclosure.

As used herein, the terms "comprises," "comprising," "includes," "including," "has," "having" or any other variation thereof, are intended to cover a nonexclusive inclusion. For example, a composition, a process, method, article, or apparatus that comprises a list of elements is not necessarily limited to only those elements but may include other elements not expressly listed or inherently present therein.

As used herein the terms "approximately," "about," "substantially" and variations thereof are intended to include not only the exact value qualified by the term, but to also include some slight deviations therefrom, such as deviations caused by measuring error, manufacturing tolerances, wear and tear on components or structures, stress exerted on structures, and combinations thereof, for example.

Use of the "a" or "an" are employed to describe elements and components of the embodiments herein. This is done merely for convenience and to give a general sense of the inventive concepts. This description should be read to include one or at least one and the singular also includes the plural unless it is obvious that it is meant otherwise.

Any reference to "one embodiment" or "an embodiment" means that a particular element, feature, structure, or characteristic described in connection with the embodiment is included in at least one embodiment. The appearances of the phrase "in one embodiment" in various places in the specification are not necessarily all referring to the same embodiment. Moreover, it will be understood that features of one embodiment may be combined with features of other embodiments, even if not expressly recited or described as a combination.

1. A tow hitch system, the system comprising:
a ball adapter having a spherical ball head;
a coupler having a recess shaped complementary to the ball head for receiving the ball head such that, following insertion of the ball adapter into the recess, the recess fully encloses the ball head of the ball adapter; and
a securing feature for resisting removal of the ball adapter from the recess while permitting the ball head to rotate within the coupler about a longitudinal axis of the ball adapter.

2. The system of claim 1, wherein the ball head is connected to a cylindrical neck, the neck having a diameter less than a diameter of the ball head, and wherein the recess is also shaped complementary to at least a portion of the neck.

3. The system of claim 2, wherein the ball adapter has a flared collar connected below the neck, the flared collar flaring outward from a diameter that matches the diameter of the neck to a diameter greater than the diameter of the neck.

4. The system of claim 3, wherein the recess includes a flared portion that is shaped complementary to the flared collar.

5. The system of claim 1, wherein the recess fully encloses the ball head and at least a portion of the neck of the ball adapter.

6. The system of claim 1, wherein a cylindrical portion of a wall of the recess surrounds an entire circumference of the neck of the ball adapter.

7. The system of claim 1, wherein a spherical portion of a wall of the recess surrounds an entire diameter of the ball head of the ball adapter.

8. The system of claim 1, wherein the securing feature comprises a pin extending through a through hole in the coupler.

9. The system of claim 2, wherein the securing feature comprises a pin positioned to partially extend through the recess at a position adjacent to the neck of the ball adapter.

10. The system of claim 1, wherein the securing feature comprises a D-pin.

11. The system of claim 1, wherein the coupler has a unitary body.

12. The system of claim 1, wherein the securing feature is connected to or integral with the coupler.
